(19) United States
(12) Patent Application Publication
(10) Pub. No.: US 2007/0119435 A1
(43) Pub. Date: May 31, 2007

(54) Engine monitoring and performance control system

(75) Inventors: Kyle Eugene Carter, Fort Collins, CO (US); Doyle Kent Stewart, LaPorte, CO (US)

Correspondence Address: CR MILES, P.C.;CRAIG R. MILES, 405 MASON COURT, SUITE 119, FORT COLLINS, CO, 80524, US

(73) Assignee: Advanced Injection Technologies, Inc.

(21) Appl. No.: 11/605,821

(22) Filed: Nov. 29, 2006

Related U.S. Application Data
(60) Provisional application No. 60/741,237, filed on Nov. 30, 2005.

(51) Int. Cl. F02B 23/00

(52) U.S. Cl. 123/585

(57) ABSTRACT

An internal combustion engine performance analysis and control logic which utilizes engine performance characteristics to control fuel and oxidizer delivery to the engine for combustion.

This patent application claims the benefit of U.S. Provisional Patent Application No. 60/741,237, filed Nov. 30, 2005, hereby incorporated by reference herein.

### I. BACKGROUND

An internal combustion engine performance analysis and control logic which utilizes engine performance characteristics to control fuel and oxidizer delivery to the engine for combustion.

The combustion of fuels within an internal combustion engine is rarely perfect and even with the correct air to fuel ratio (“AFR”), combustion can still be incomplete. Typically, there remains an unburned boundary layer of air to fuel mixture insulating the metal components of the combustion chamber from the propagating flame front of burning air and fuel mixture originating at the spark plug. A lean air to fuel mixture can burn with such efficiency as to consume all or a part of the insulating boundary layer allowing the flame front to engage the combustion chamber walls. At those locations where the flame front engages the combustion chamber walls, there can be a dramatic rise in temperature, high enough to cause subsequent charges of air and fuel to spontaneously ignite resulting in multiple flame fronts. This is pre-ignition which precedes each flame front can generate a sonic pressure wave whose collisions we hear as knocking and pinging. Allowed to persist, colliding sonic pressure waves tend to focus on the edges of pistons, valves, and even the spark plug to cause severe engine damage.

Nitrous oxide is a gaseous mixture of two parts nitrogen and one part oxygen (N2O). Nitrous oxide can be stored as a liquid and coverts into a gas upon injection into the engine. That conversion can reduce overall inlet-air temperature by absorbing heat, contributing to increased engine power by making the air to fuel mixture denser. During combustion in the combustion chamber of the engine, the oxygen separates from the nitrogen molecule and becomes available to oxidize additional fuel. The nitrogen molecules can act as a buffer to combustion, slowing the burning process to a more manageable rate as opposed to a violent explosion that is extremely hard on pistons, rods and crankshafts. That's why nitrous oxide is typically used as opposed to pure oxygen. However, the use of nitrous oxide must accompany the use of a sufficient amount of additional fuel to avoid the above-described dangerously lean air to fuel ratios and damage to the engine.

Controlling the amount of additional fuel introduced into the combustion chamber of the engine to obtain the desired AFR can be difficult in the context of nitrous oxide use and engines which may have modifications involving or due to increased displacement, fuel intake, engine wear, or fuel composition in various permutations and combinations.

Additionally, conventional engine control units which regulate fuel injection and conventional boost valve control units which regulate boost may not adequately control fuel injection duration or amount of boost in the context of modified engines or engines which use additional fuel and nitrous oxide.

### II. SUMMARY OF THE INVENTION

Accordingly, a broad object of the invention can be to provide an internal combustion engine performance analysis and control logic which utilizes engine performance characteristics to control fuel and oxidizer delivery to the engine for combustion.

Another broad object of the invention can be to deliver nitrous oxide and additional fuel to an internal combustion engine only under the condition that assessed actual air to fuel ratio delivered to the engine occur within a pre-selected range of air to fuel ratios and not under the condition that assessed actual air to fuel ratio delivered to the engine occurs outside of the pre-selected range of air to fuel ratios.

Another broad object of the invention can be to deliver nitrous oxide and additional fuel to an internal combustion engine only under the condition that assess revolutions per minute of the engine occur within a pre-selected range of air to fuel ratios and not under the condition that assessed actual revolutions per minute of the engine occur outside of the pre-selected range of revolutions per minute.

Another broad object of the invention can be to deliver nitrous oxide and additional fuel to an internal combustion engine only under the condition that assessed actual manifold pressure occurs within a pre-selected range of manifold pressure and not under the condition that assessed manifold pressure occurs outside of the pre-selected range of manifold pressures.

Another broad object of the invention can be to deliver nitrous oxide and additional fuel to an internal combustion engine only under the condition that a delivery time occurs within a pre-selected duration of elapsed time and not under the condition that the delivery time occurs outside of the pre-selected duration of elapsed time.

Another broad object of the invention can be to deliver nitrous oxide and additional fuel only under the condition that each of a plurality of assessed engine performance characteristics occur within a corresponding pre-selected range for each of the engine performance characteristics (actual air to fuel ratio, engine revolutions per minute, manifold pressure, delivery time) and not under the condition that any one of the assessed engine performance characteristics occurs outside of the corresponding pre-selected range.

Another broad object of the invention can be to alter the boost control sensor signal based upon assessed actual engine performance characteristics (air to fuel ratio, manifold pressure, engine revolutions per minute) and provide an altered boost control signal to the boost control valve to adjust the amount of boost delivered to the engine whether or not in combination with delivery of additional fuel or nitrous oxide to the engine.

Another broad object of the invention can be to alter the manifold absolute pressure sensor signal provided to the engine control unit to adjust fuel delivery duration time of fuel injectors whether not in combination with delivery of additional fuel or nitrous oxide to the engine.

Another broad object of the invention can be to alter engine performance characteristics (air to fuel ratio, boost, engine revolutions per minute) and fuel composition under the condition that actual air to fuel ratio exceeds a preset air to fuel ratio.

Naturally, further objects of the invention are disclosed throughout other areas of the specification, drawings, photographs, and claims.

### III. A BRIEF DESCRIPTION OF THE DRAWINGS

FIG. 1 is flow diagram of an embodiment of the internal combustion engine performance analysis and control logic invention which utilizes engine performance characteristics to control fuel and oxidizer delivery to the engine for combustion

FIG. 2 is a flow diagram of an embodiment of a portion of the control logic architecture of the invention.

FIG. 3 is a flow diagram of an embodiment of a fuel valve operation application of the invention.

FIG. 4 is a flow diagram of an embodiment of a revolutions per minute application of the invention.

FIG. 5 is flow diagram of an embodiment of a reMAP application of the invention.

FIG. 6 is a flow diagram of an embodiment of a MAP application of the invention.

FIG. 7 is a flow diagram of an embodiment of a boost control application of the invention.

FIG. 8 is a flow diagram of an embodiment of a timer application of the invention.

FIG. 9 is cross section view of a particular embodiment of a progressive valve which can be incrementally adjusted between and open condition and a closed condition.

FIG. 10 is cross section view of a particular embodiment of a progressive valve which can be incrementally adjusted between and open condition and a closed condition.

### IV. DETAILED DESCRIPTION OF THE PREFERRED EMBODIMENTS

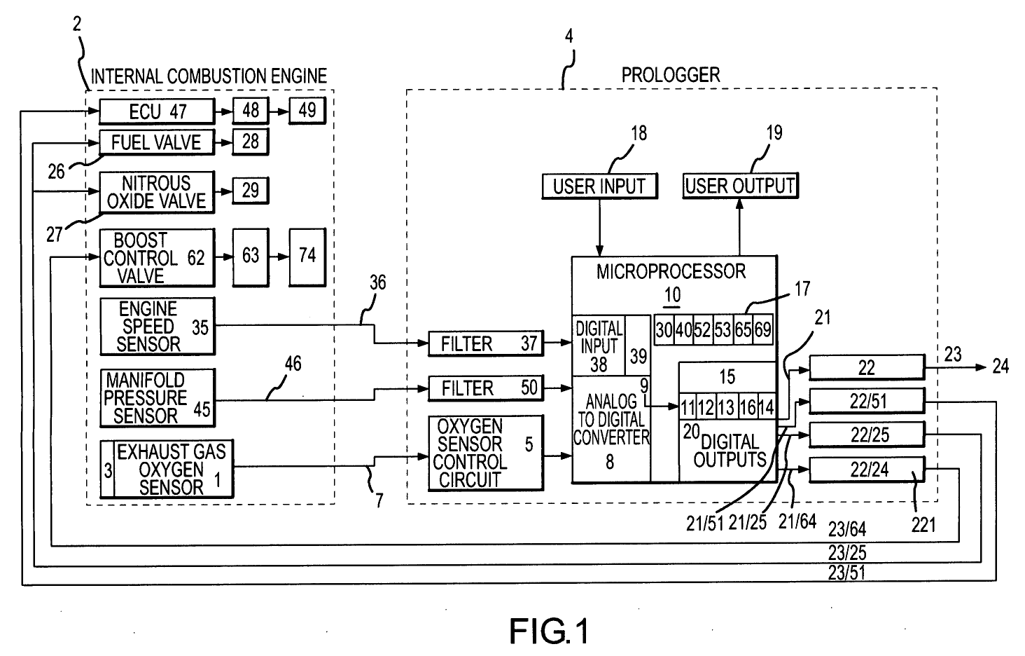

Now referring primarily to FIG. 1, particular embodiments of the invention can provide an exhaust gas oxygen sensor (1) coupled to the exhaust pipe of a motor vehicle proximate to the engine (2) allowing the exhaust gas oxygen sensor (1) to be responsive to fuel combustion exhaust gas (3). The exhaust gas oxygen sensor (1) of the invention can encompass many constructional forms which are similar in nature whether narrow band or wide. For example, a wide band oxygen sensor, such as the Bosch LSU 4.2 Planar Wide Band Lambda Sensor, can provide a relatively wide range response to various air to fuel ratios. Robert BoschGMbH, Technical Customer Information, Planar Wide Band Lambda Sensor, LSU 4.2, 0 258 007/A 258 400, hereby incorporated by reference herein.

Typically, a wide band oxygen sensor consists of two parts: a Nernst measurement cell and an oxygen pump cell, co-existing in a package that contains a reference chamber and heater element used to regulate the temperature of the Nemst-oxygen pump cell. The Nernst cell and oxygen pump cell can each face a diffusion gap into which fuel combustion exhaust gas (3) to be sensed enters. The Nernst measurement cell generates current based upon the amount of oxygen contained in the fuel combustion exhaust gas (3). The oxygen pump cell transports oxygen into and out of the exhaust gas (3) in the diffusion gap to maintain a substantially constant Nernst measurement value (typically of about 0.45 volts or other voltage value corresponding to a balanced stoichiometric air to fuel ratio or other desired air to fuel ratio). The amount of oxygen pump cell current utilized to achieve the balanced stoichiometric air to fuel ratio can be measured allowing determination of the actual air to fuel ratio the engine (2) receives.

While the specific example of the Robert BoschGMbH, Planar Wide Band Lambda Sensor, LSU 4.2, 0 258 007/A 258 400 has been described, this specific example is not intended to limit the invention to the use of this particular wide band exhaust gas oxygen sensor and various similar or equivalent wide band exhaust gas oxygen sensors and certain narrow band exhaust gas oxygen sensors or other exhaust gas oxygen sensors which can generate a signal based upon the amount of oxygen in the fuel combustion exhaust gas may also be utilized to assess the actual air to fuel ratio received in the combustion chamber of the engine (2).

Again referring primarily to FIG. 1, the invention can further provide a computer (4) which in part can provide an oxygen sensor control element (5) which can continuously regulate the components of the exhaust gas oxygen sensor (1), such as regulating a wide band oxygen sensor (1) with respect to adjustment of pump current, sensor temperature, and assessment of the amount of pump current, to allow an analog signal (7) to be generated based upon the actual air to fuel ratio the engine (2) receives. An example of a suitable oxygen sensor control element (5) which can be utilized with the above-described Robert BoschGMbH, Planar Wide Band Lambda Sensor, LSU 4.2, 0 258 007/A 258 400 can be a Robert Bosch GMbH CJ125 circuit as described by Robert BoschGMbH, Datasheet CJ125, hereby incorporated by reference herein. Naturally, the oxygen sensor control element (5) can correspondingly be selected to control the specific exhaust gas oxygen sensor (1) utilized with a given embodiment of the invention to generate an analog signal (or other signal) based upon the actual air to fuel ratio the engine (2) receives.

The computer (4) can further provide an analog signal to digital signal converter (8) which converts the continuously varying analog signal (7) from the oxygen sensor control element (5) into a binary signal (9) that represents equivalent information. The analog signal to digital signal converter (8) can be a discrete element such as a Texas Instruments TVP7000, or can be one element of a plurality of elements contained within a microprocessor (10), such as a Microchip Technology, Inc., PIC18F6520 microcontroller with A/D. Microchip, PIC18FT520/8520/6620/8620/6720/8720 Data Sheet hereby incorporated by reference herein. Again, these specific examples of analog to digital converters (8) and microprocessors (10) are not intended to be limiting with respect to the numerous and varied analog to digital converters (8) which can be used to generate the binary signal (9) which can be processed by correspondingly wide variety of microprocessors (10) which can be included in a wide variety of computer (4) constructional forms or equivalent computer means such as personal digital assistants, cell phones, multiprocessor systems, microprocessor-based or programmable consumer electronics, network PCs, minicomputers, mainframe computers, or the like.

As such, the computer (4) of the invention can broadly encompasses a wide variety of constructional forms which include at least one processor element (11); a memory element (12) which can include a read only memory (ROM) (13) or random access memory (RAM) (14), or both, and a bus which operably couples components of the computer (4), including without limitation the memory element (12) to the processor element (11). Additionally, the computer can further include one or plurality of timers (15). The processor element (11) can comprise one central-processing unit (CPU), or a plurality of processing units which operate in parallel to process the binary signal (9) or other digital information. As to certain embodiments of the invention a basic input/output system (16), containing routines that assist transfer of data between the components of the computer (4), such as during start-up, can be stored in ROM (13). The computer (4) can as to certain embodiments of the invention further include a hard disk drive for reading from and writing to a hard disk, a magnetic disk drive for reading from or writing to a removable magnetic disk, or an optical disk drive for reading from or writing to a removable optical disk such as a CD ROM or other optical media, individually or in various permutations or combinations. A number of program modules may be stored on the hard disk, magnetic disk, optical disk, ROM (13), or RAM (14), including an operating system, one or a plurality of application programs, other program modules, or program data.

Again referring primarily to FIG. 1, the computer (4) can further include computer-executable instructions (17) such as program applications which utilize routines, objects, components, data structures, logic structures, or the like, to perform particular functions or tasks or implement particular abstract data types, or the like. It is not intended that the invention be limited to the particular set of computer-executable instructions (17) or protocols described herein. Rather, certain embodiments of the invention can encompass other embodiments of the computer-executable instructions (17) or program applications which can generate the functions or tasks as further described below.

The computer (4) can further include an input element (18) such as a key pad, or keyboard and pointing device such as a mouse. Other embodiments of the input element (18) may include a microphone, joystick, game pad, satellite dish, scanner, or the like. These and other input devices are often connected to the processing unit (11) through a serial port interface that can be coupled to the bus, but may be connected by other interfaces, such as a parallel port, game port, or a universal serial bus (USB). Similarly, the invention can provide an output element (19) such as a plurality of light emitting diodes to display characters, a monitor, or other type of display device connected to the bus via a corresponding interface element, such as a video adapter or the like. In addition to the output element (19), the computer (3) can further include other peripheral output devices such as speakers and printers.

A input event occurs when the user operably engages the input element (18) to operate all or part of the computer executable instructions (17) to perform an application, function, or task through the use of a command which for example can include pressing or releasing the buttons on a key pad in a particular order, or pressing or releasing the left mouse button while a pointer is located over a control icon displayed by the output element (19) or monitor. However, it is not intended that a input event be limited to the press and release of buttons on a key pad, or the press and release of the left button on a mouse while a pointer is located over a control icon, rather, the term input event is intend to broadly encompass a command by the user through which a application, function, or task can be performed by all or a part of the computer executable instructions (17).

Now referring primarily to FIG. 1, the computer (4) can further provide one or a plurality of digital output elements (20) which convert binary values generated by the operation of the computer executable instructions (17) to an output current (21), such as a flow of electric charge or the amount of electric charge flowing past a specified circuit point per unit time. Depending on the part of computer executable instructions (17) applied to the digital signal (9) the output current (21) generated by the digital output element (20) can have a fixed value regulated between an off condition and an on condition. Alternately, the output current (21) generated by the digital output element (20) can be regulated between an off condition and an on condition and can further have a variable value during the duration of the on condition. An amplifier (22) can be used to convert the output current (21) from the digital output element (20) to provide an amplified output current or amplified current force (23), whether a fixed value or variable value during the duration of the on condition, such as an amplified current force (23) in the range of about zero volts and about five volts (24) which can be utilized to power the various sensors or components of the invention, or otherwise which allows the function of valves or components of the invention as further described below.

As shown by FIG. 1, the amplified output current (23/25)) can be used to indirectly signal operation of or directly operate a fuel valve (26) or a nitrous oxide valve (27), or both, between a closed condition which prevents or reduces delivery of fuel (28) or delivery of nitrous oxide (29)(or both) to the combustion chambers of the engine (2) and an open condition which increases delivery of fuel (28) or delivery of nitrous oxide (29)(or both) to the combustion chambers of the engine (2), such operation of the fuel valve (26) or the nitrous valve (27)(or both) can provide only a first open condition and only a second closed condition of the valve, or can provide a variable adjustment between the open condition and the closed condition.

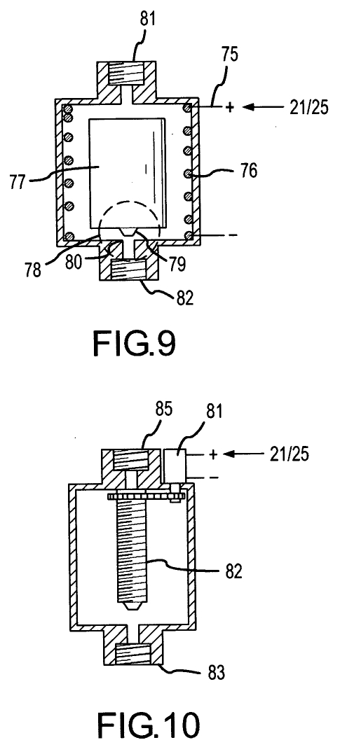

In a particular embodiment of the invention, the fuel valve (26) and the nitrous oxide valves (27) can be or be similar to those distributed by Magnum Force, Inc., 1436 White Oaks Road, #7, Campbell, Calif. For example, Magnum Force, Inc., Super Powershot Nitrous Solenoid, #16020 and the Super Powershot Fuel Solenoid, #16080 although the invention is not so limited and any fuel valve (26) or nitrous oxide valve (27) operable by delivering the output current (21/25) or the amplified output current (23/25) to provide only two conditions such as a closed condition and an open condition, or operable by delivering a variable output current (21/25) or a variable amplified output current (23) to provide a graded series of conditions between a closed condition and an open condition of a proportional nitrous oxide valve (27) or fuel valve (26), such as those valves shown by FIGS. 9 and 10. As can be understood by FIG. 9, the output current (21/25) can regulate the amount of current (75) delivered to a coil (76) to generate an electromagnetic field to which a plunger element (77) responds to operate a valve (78) having a pintle (79) which engages a valve seat (80) between an open condition and an a closed condition to regulate amount of fuel (28) or nitrous oxide (29) which passes between an inlet element (81) and an outlet element (82). As shown by FIG. 10, the output current (21/25) can be used to provide a signal which controls rotational operation of a motor (81) to which a threaded shaft (82) rotationally locates a needle (83) with respect to a seat (84) to regulate amount of fuel (28) or nitrous oxide (29) which passes between an inlet element (85) and an outlet element (86).

As to certain embodiments of the invention, the fuel valve (26) can be a one each fuel valve, a pair of fuel valves, or a plurality of fuel valves. Similarly, as to particular embodiments of the invention, the nitrous oxide valve (27) can be a one each nitrous oxide valve, a pair of nitrous oxide valves, or a plurality of nitrous oxide valves. The amplified output current (23/25) can be delivered by circuits configured to operate a particular constructional form of the fuel valve (26) or the nitrous oxide valve (27). As but one example, the amplified output current (23/25) can be delivered by a first circuit configuration which allows a first fuel valve and a first nitrous oxide valve to both operate in response to the on condition or the off condition of the amplified output current (23/25). Typically, both the first fuel valve and the first nitrous oxide valve achieve the open condition or the closed condition in response to the on condition or the off condition of the first amplified output current to deliver a corresponding first amount of fuel (28) and a first amount of nitrous oxide (29). Similarly, the amplified output current (23/25) can be delivered by a second circuit configuration to allow a second fuel valve and a second nitrous oxide valve to both operate in response to a second amplified output current to deliver a corresponding second amount of fuel (28) and a second amount (29) of nitrous oxide (which as to both can be the same amount or different amounts depending on the application). Typically, both the second fuel valve and the second nitrous oxide valve achieve the open condition or the closed condition in response to the on condition or the off condition of the amplified output current. Additionally, the amplified output current (23/25) can be delivered by a third circuit configuration which allows the first fuel valve and the first nitrous oxide valve and the second fuel valve and the second nitrous oxide valve to all operate in response to the on condition or the off condition of the amplified output current (23/25) which delivers a corresponding third amount of fuel (28) and nitrous oxide (29) to the combustion chambers of the engine (2).

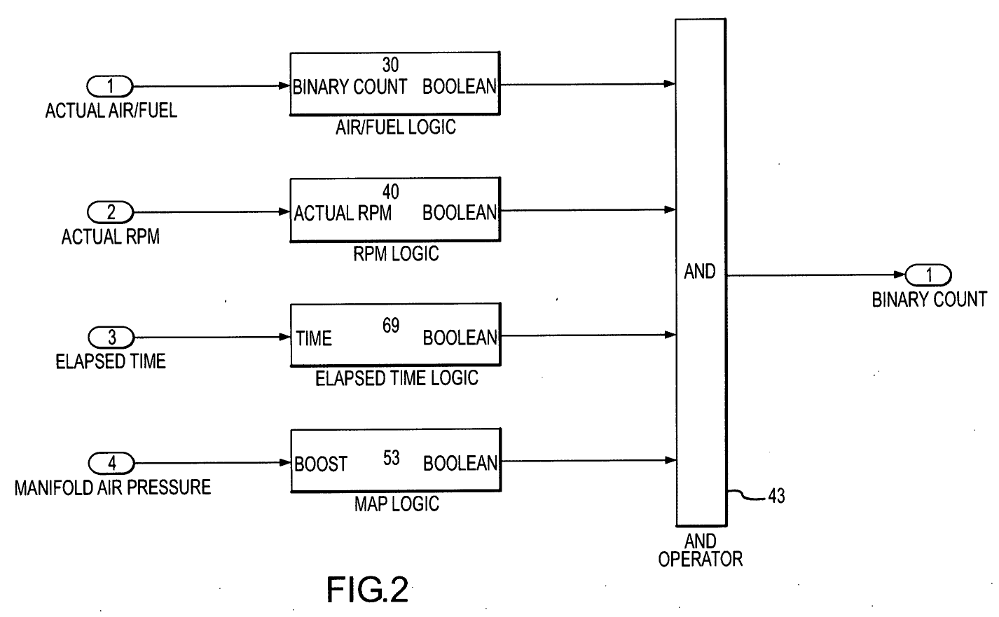

Now referring primarily to FIGS. 1 and 2, as can be understood from the above description, the analog signal (7) from the exhaust gas oxygen sensor (1) can be converted to a binary signal (9) which continuously varies based upon the assessed actual air to fuel ratio received in the combustion chamber of the engine (2). A set of computer operable instructions (17) can be applied to the binary signal (9) to generate either the on condition or the off condition of the output current (21/25) which can be amplified (22/25), if necessary, to operate the fuel valve (26) and the nitrous oxide valve (27), as above-described or in other constructional configurations, to allow continuous adjustment of the amount of fuel (28) and the amount of nitrous oxide (29) delivered to the combustion cylinders of the engine (2) toward a desired air to fuel ratio, or to move away from an undesired air to fuel ratio, or to maintain air to fuel ratio in a limited range between about a first air to fuel ratio and a second air to fuel ratio.

Now referring primarily to FIG. 2, a part of the computer executable instructions (17) encompassed by the invention can include a fuel valve operation application (27) which functions to establish the amplified output current (23/25) in the on condition for so long as the assessed actual air to fuel ratio received in the combustion chamber of the engine (2) has an air to fuel ratio value within a range of air to fuel values having established air to fuel ratio endpoints and can establish the amplified output current (23/25) in the off condition for so long as the assessed actual air to fuel ratio received in the combustion chamber of the engine (2) has a air to fuel ratio value outside the established air to fuel ratio endpoints.

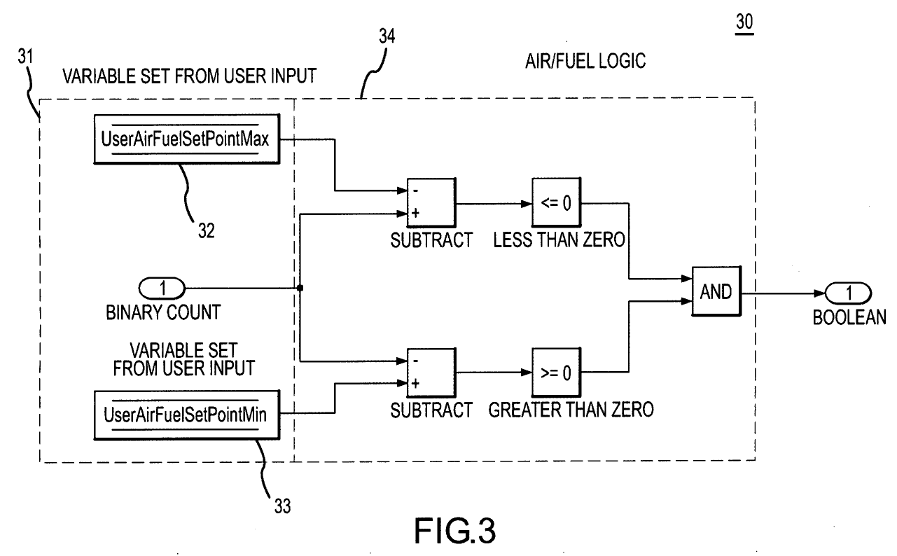

As shown primarily by FIG. 3, the fuel valve operation application (30) provides an air to fuel ratio end point input function (31) which allows the user of the computer (4) to perform an input event with the input element (18) to set a first air to fuel ratio end point (32) and a second air to fuel ratio end point (33) which can be utilized by a fuel valve operation logic (34) to establish an air to fuel ratio value range within which the output current (21/25) or amplified output current (23/25) remains in the on condition and outside of which the output current (21/25) or amplified output current (23/25) remains in the off condition.

As but one non-limiting example, the fuel valve operation logic (34) can allow the first air to fuel ratio endpoint (32) to be variably adjusted by the user to an air to fuel ratio value of 16.0:1 (from a range of selectable air to fuel ratio values) and the second fuel to air ratio endpoint (33) to be variably adjusted by the user to 10.0:1 (from a range of selectable air to fuel ratio values). The fuel valve operation logic (34) maintains the output current (21/25) or the amplified output current (23/25) in the on condition for so long as the assessed actual air to fuel ratio received by the combustion chambers of the engine (2) falls within the air to fuel ratio value range established between the selected air to fuel ratio endpoints (32)(33) of 16.0:1.0 and 10.0:1.0 (or other selected air to fuel ratio endpoints) established by the user through an input event to the input element (18).

While the FIG. 3 provides a particular embodiment of the fuel valve operation logic (34), other embodiments of the fuel valve operation application (30) could be configured to provide the above described functions to allow continuous adjustment of the amount of fuel (28) and the amount of nitrous oxide (29) delivered to the combustion cylinder of the engine (2) toward a desired air to fuel ratio, to move away from an undesired air to fuel ratio, to avoid a lean air to fuel ratio which could result in damage to the engine (2), or to maintain an air to fuel ratio in a limited range between about a first air to fuel ratio and a second air to fuel ratio. Additionally, the fuel valve operation application (30) can further provide a fuel valve operation logic (34) to establish a graded series of output current (21/25) values to operate fuel valves (26) or nitrous oxide valves (27) which can be incrementally adjusted between an open condition and a closed condition to adjust the actual air to fuel ratio received in the combustion chamber of the engine (2)

Again referring primarily to FIG. 1, certain embodiments of the invention can further include engine speed sensor (35) which generates a engine speed signal (36) based upon sensing the periodic operation of the crankshaft, camshaft, capacitive discharge system, output of an electronic amplifier, or the like. An engine speed signal filter (37), such as a resistor capacitor first order low pass filter can limit the bandwidth, noise, or frequencies above the analog to digital nyquist frequency to establish the engine speed signal (36) in a useful range which can be received by an engine speed assessment element (38), such as the capture module of the PIC18F6520 microcontroller which can establish engine period for conversion to frequency by applying a frequency assessment logic (39).

Again referring primarily to FIG. 2, a part of the computer executable instructions (17) applied to the binary signal (9) encompassed by the invention can include a revolutions per minute application (40) which functions to establish the output current (21/25) in the on condition for so long as the assessed revolutions per minute (RPM) of the engine (2) has an RPM value within a range of RPM values having established RPM endpoints (41)(42) and to establish the output current (21/25) in the off condition for so long as the assessed RPM of the engine (2) has a RPM value outside the established RPM endpoints (41)(42). Additionally, as to certain embodiments of the invention, the computer executable instructions (17) can further provide an AND function (43) which only allows operation of the output current (21/25) in the on condition so long as both the assessed actual RPM of the engine (2) and the assessed actual air to fuel ratio received by the engine (2) are within the range of RPM values established by the RPM endpoints (41)(42) and the within the range of air to fuel values established by the air to fuel ratio endpoints (32)(33).

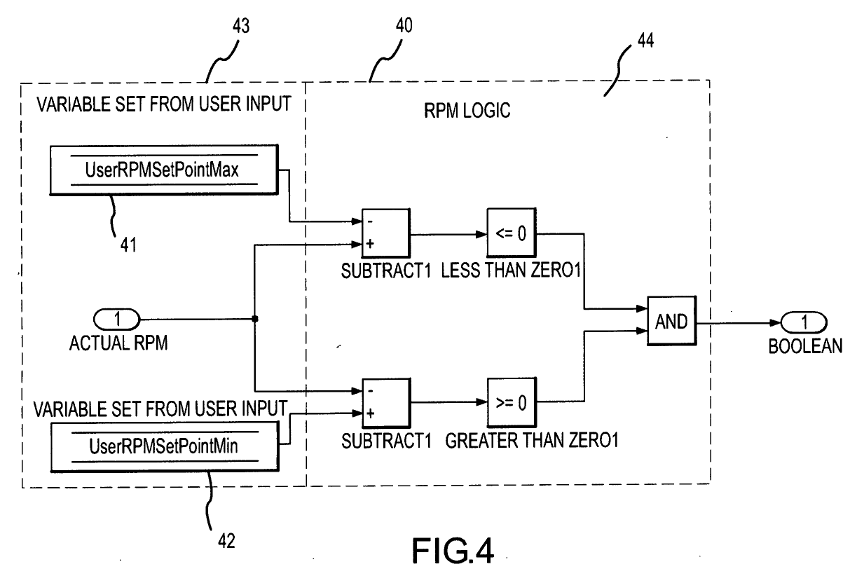

As shown primarily by FIG. 4, the RPM application (40) provides an RPM end point input function (43) which allows the user of the computer (4) to generate an input event with the input element (18) to set a first RPM end point (41) and a second RPM end point (42) utilized by a RPM logic (44) to establish a RPM value range within which the output current (21/25) remains in the on condition and outside of which the output current (21/25) remains in the off condition (further subject to operation of the AND logic (43)). For example, the RPM logic element (44) can allow the first RPM endpoint (41) to be variably adjusted by the user to a RPM value of 5,000 RPM and the second RPM endpoint (42) to be variably adjusted by the user to 2,000 RPM (or other RPM endpoints as desired). The RPM logic (44) functions to maintain the output current (21/25) in the on condition for so long as the assessed actual RPM of the engine (2) falls within the RPM value range established between the RPM endpoints (41)(42) of 5,000 and 2,000 (or otherwise) selected by the user.

Again referring primarily to FIG. 1, certain embodiments of the invention can further include a manifold absolute pressure sensor (MAP sensor) (45) coupled to the intake manifold of the engine (2) to monitor the difference in pressure between the intake manifold and the outside atmosphere. The MAP sensor (45) can generate a manifold pressure analog signal (46) which continuously varies with engine load (as engine load increases manifold vacuum decreases). Conventionally, the manifold pressure analog signal (46) can be transformed into an electronic response which conventional engine control units (ECU) (47) utilize to set the pulse duration of a plurality of fuel injectors (48) to deliver an amount of fuel (49) to the combustion chambers of the engine (2). However, conventional ECUs (47) may be open loop and have no air to fuel ratio feedback compensation for fuel to air ratios altered due to engine modification (larger displacement, intake modifications, or the like), engine wear, or fuel composition.

By way of contrast, certain embodiments of the invention can further include a manifold pressure analog signal filter (50), such as a resistor capacitor first order low pass filter, which can limit the bandwidth, noise, or frequencies above the analog to digital nyquist frequency of the manifold pressure analog signal (46). The filtered manifold pressure analog signal can be received by the analog to digital converter (8) which can generate the corresponding binary signal (9) which continuously varies based upon the manifold absolute pressure of the engine (2). A part of the set of computer operable instructions (17) can be applied to the binary signal (9) to generate an ECU compensation output current (21/51) which can be amplified (22/51), if necessary, to provide an amplified ECU compensation output current (23/51) which can alter conventional operation of the ECU (47) which then correspondingly adjusts the amount of a fuel (49) conventionally delivered by the fuel injectors (48) to the combustion cylinder of the engine (2) toward a desired air to fuel ratio, or to move away from an undesired air to fuel ratio, or to maintain air to fuel ratio in a limited range between about a first air to fuel ratio and a second air to fuel ratio selected by the user.

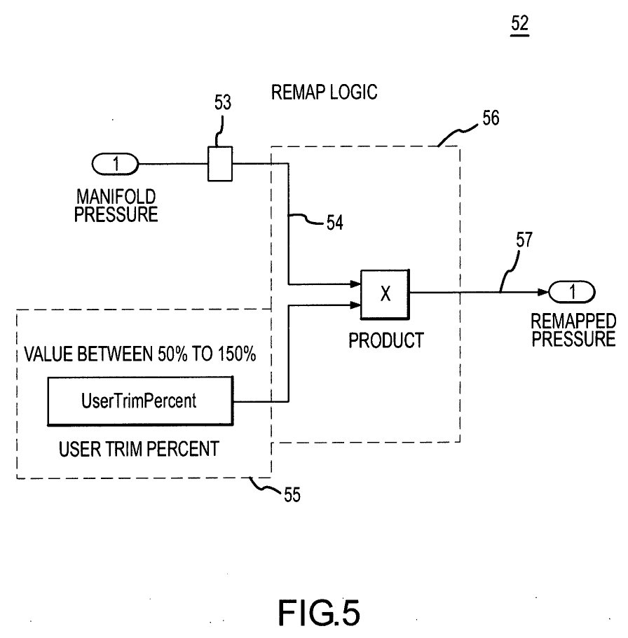

Now referring primarily to FIG. 5, certain embodiments of the invention can further include as part of the computer operable instructions (17) a reMAP application (52) which can be utilized separately or in combination with a manifold air pressure application (53)(“MAP application”)(further described below) to alter the manifold pressure analog signal (46) conventionally received by the ECU (47). The reMAP application (52) provides a MAP senosor signal valuation element (53) which generates MAP sensor signal value (54), a manifold pressure signal trim element (55) which allows the user to utilize the input element (18) to generate an input event to establish a trim value within a range of trim values such as between about fifty percent and about one hundred and fifty percent (although certain embodiments of the invention may provide other trim value ranges), and a remap logic (56) which can generates reMAP value (57) which varyingly corresponds to the product of the MAP sensor signal value (54) and the trim value. The reMAP value (57) can be utilized to generate the ECU compensation output current (21/51) received by the ECU (47) to alter the conventional operation of the ECU (47) to correspondingly adjust the amount fuel (49) delivered by the fuel injectors (48).

Now referring primarily to FIG. 2, the manifold pressure analog signal (46) suitably filtered can also be received by the analog to digital converter (8) to generate a corresponding binary signal (9) which continuously varies based upon the manifold absolute pressure of the engine (2) to which a manifold absolute pressure application (53)(“MAP application”) can be applied to establish the output current (21/25) in the on condition for so long as the manifold absolute pressure has an absolute pressure within a range of absolute pressure values established by manifold absolute pressure endpoints (58)(59) and to establish the output current (21/25) in the off condition for so long as the manifold absolute pressure has a manifold absolute pressure value outside the established absolute manifold absolute pressure endpoints (53)(54). Additionally, as to certain embodiments of the invention, the computer executable instructions (17) can further provide the AND operator (43) which only allows operation of the output current (21/25) in the on condition so long as the other applications (30)(40)(or others) also correspondingly establish the output current (21/25) in the on condition.

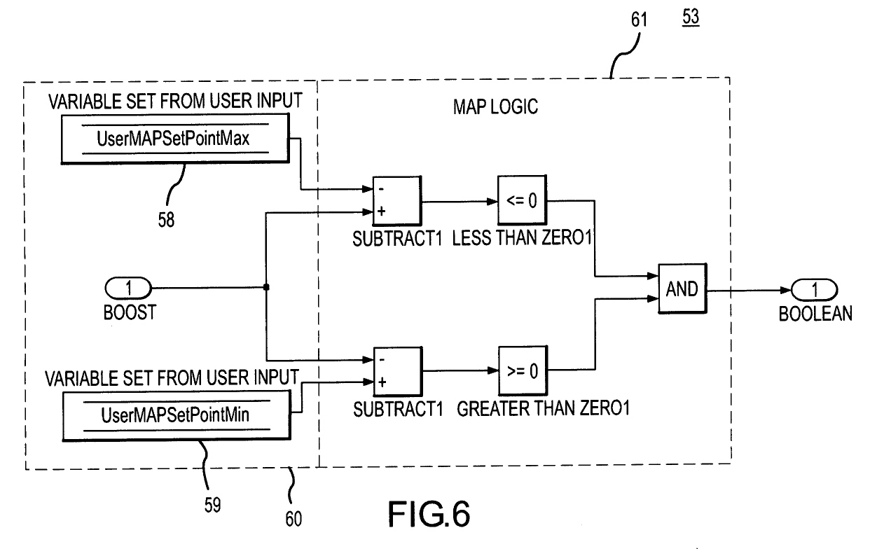

As to particular embodiments of the invention, as shown by FIG. 6, the MAP application (53) provides a MAP end point input function (60) which allows the user of the computer (3) to generate an input event with the input element (18) to set a first MAP end point (58) and a second MAP end point (59) which can be utilized by a MAP logic (61) to establish a MAP value range within which the output current (21/25) remains in the on condition and outside of which the output current (21/25) remains in the off condition. For example, the MAP application (61) can allow the first MAP endpoint (58) to be variably adjusted by the user to a MAP value of 20 inches Hg and the second MAP endpoint (59) to be variably adjusted by the user to 0.5 inches Hg. The MAP logic (61) maintains the output current (21/25) in the on condition for so long as the assessed actual MAP falls within MAP value range established between the MAP endpoints (58)(59) of 20 inches Hg and 0.5 inches Hg set by the user.

Again referring primarily to FIG. 1, the invention can further provide a turbocharger having a waste gate (63) which operates in response to the pressure of the air entering the engine (2) (the “boost” (74)). With respect to conventional turbochargers, the waste gate (63) allows exhaust gas to bypass the turbine of the turbocharger thereby limiting the available turbine drive energy. The waste gate (62) can be held shut by a spring, and as boost (74) builds, a boost control actuator diaphragm responsive to the increasing boost pressure operates against the spring to open the waste gate (63). The size of the boost control actuator diaphragm and strength of the spring determines how much boost (74) it takes to open the waste gate (63). By further providing a boost control valve (62) which operates between an open condition and a closed condition to regulate the amount of pressure delivered to the boost control actuator diaphragm (in particular embodiments of the invention by operation of a vent which allows complete or partial equilibrium with atmospheric pressure), the boost control valve actuator diaphragm can be made responsive to a greater or lesser extent (as compared to the conventional boost control actuator operation) to the amount of boost pressure generated.

By decreasing the pressure on the boost control actuator diaphragm allows the waste gate (63) to remain in the closed condition for an increased duration of time allowing boost to increase while increasing pressure on the boost control actuator diaphragm allows the waste gate (63) to establish the open condition in a decreased amount of time allowing boost to decrease. Alternately, the waste gate (63) can include a variably adjustable opening which can be operated by a stepper motor to incrementally vary the open area of the waste gate (63). See for example, the HKS USA, EVC-EZ, EVC IV. The stepper motor can be variably controlled to incrementally open or close by the correspondingly varied boost valve signal (23/64).

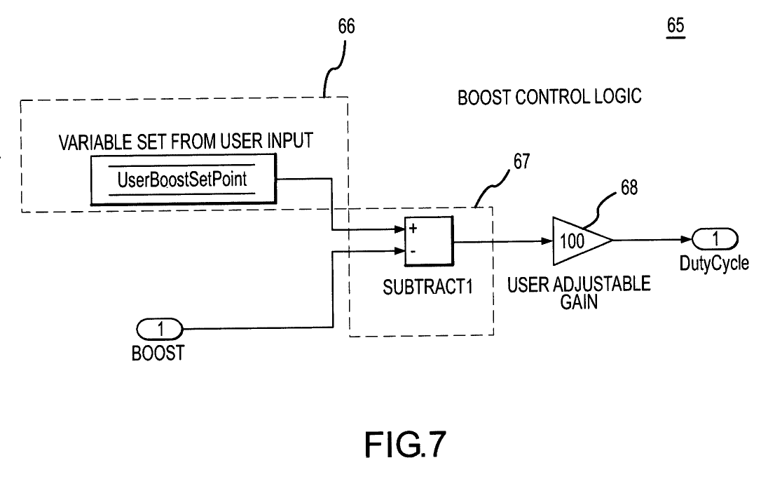

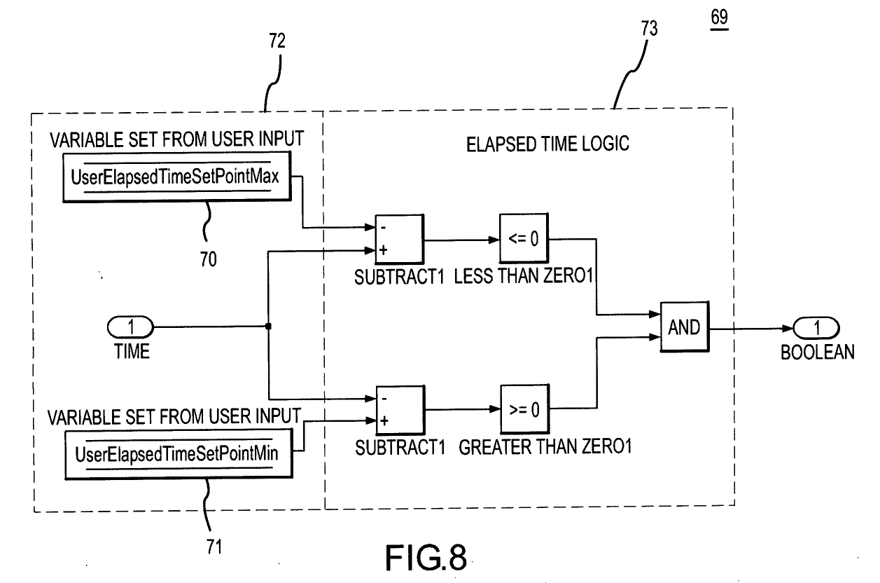

Now referring to FIG. 7, certain embodiments of the invention can further include as part of the computer operable instructions (17) a boost control application (65) which in part provides a boost set point input function (66) which allows a user to generate an input event with the input element (18) to set a boost set point value which can be utilized by the boost logic (67) as a threshold below which the output current (21/64) can be established in the on condition and above which the output current (21/64) can be established in the off condition to correspondingly operate the boost control valve (62) between the open condition and the closed condition to regulate operation of the waste gate (63), as above-described. The boost control application (65) can further provide an adjustable gain element (68) which allows the user to increase or decrease signal strength to the boost control valve (62).

Now referring primarily to FIGS. 1 and 2, the invention can further include one or a plurality of timers (15) as above-described and a part of the computer executable instructions (17) encompassed by the invention can include a timer application (69) which functions to establish the output current (21/25) in the on condition for a duration of time within a range of elapsed time values having established elapsed time endpoints (70) (71) and to establish the output current (21/25) in the off condition for so long as the actual elapsed time remains outside the established elapsed time endpoints (70) (71).

As to particular embodiments of the invention, as shown by FIG. 2, the time application (69) provides time end point input function (72) which allows the user of the computer (4) to generate an input event with the input element (18) to set a first elapsed time end point (70) and a second elapsed time end point (71) which can utilized by a elapsed time logic (73) to establish elapsed time value range within which the output current (21/25) remains in the on condition and outside of which the output current (21/25) remains in the off condition. For example, the time application (69) can be utilized in combination with the fuel valve operation application (30)(or other application(s), such as (40)(53) subject to operation of the AND element (43)) to establish a duration of time in which the fuel valve operation application (30) (or other application(s)) operate to generate the output current (21/25) in the on condition or the off condition to maintain an air to fuel ratio within the air to fuel ratio endpoints (32) (33)(or other end points depending on the application timed).

As can be easily understood from the foregoing, the basic concepts of the present invention may be embodied in a variety of ways. The invention involves numerous and varied embodiments of an internal combustion engine performance analysis and control logic which utilizes engine performance characteristics to control fuel and oxidizer delivery to the engine for combustion and methods of making and using such internal combustion engine performance analysis and control logic.

As such, the particular embodiments or elements of the invention disclosed by the description or shown in the figures accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “fuel injector” should be understood to encompass disclosure of the act of “fuel injecting”—whether explicitly discussed or not—and, conversely, were there effectively disclosure of the act of “fuel injecting”, such a disclosure should be understood to encompass disclosure of a “fuel injector” and even a “means for fuel injecting.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each of the internal combustion engine performance analysis and control logics herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth below, if any, are intended describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A method of delivering a nitrous oxide to an engine, comprising the steps of:
a. determining the amount of oxygen in an exhaust gas;
b. assessing an air to fuel ratio delivered to an engine based upon said amount of oxygen in said exhaust gas;
c. establishing an air to fuel ratio range between a pair of air to fuel ratio endpoints;
d. determining whether said air to fuel ratio delivered to said engine occurs within said air to fuel ratio range between said pair of air to fuel ratio endpoints;
e. generating an output current for a duration of time in which said air to fuel ratio occurs within said air to fuel ratio range; and
f. utilizing said output current to establish a nitrous oxide valve in an open condition for said duration of time in which said air to fuel ratio occurs within said air to fuel ratio range to deliver said nitrous oxide to said engine.
